(19) United States
(12) Patent Application Publication
(10) Pub. No.: US 2009/0060124 A1
(43) Pub. Date: Mar. 5, 2009

(54) ENERGY RESOLVED COMPUTER TOMOGRAPHY

(75) Inventors: Michael Grass, Buchholz In Der Nordheide (DE); Thomas Koehler, Norderstedt (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/718,718

(22) PCT Filed: Nov. 2, 2005
(86) PCT No.: PCT/IB05/53565

§ 371 Date: May 7, 2007

(30) Foreign Application Priority Data
Nov. 11, 2004 (GB) 0424877.9

(51) Int. Cl. H05G 1/08

(52) U.S. Cl. 378/19

(57) ABSTRACT

Interpolation of the momentum transfer prior to the filtered backprojection reconstruction in computer tomography baggage inspection or medical applications may not result in best image quality or minimal computational cost. According to an exemplary embodiment of the invention, a non-linear energy binning of an energy-resolved single-row detector is provided, which automatically leads to a Cartesian q-sampling on a parallel rebinned detector. This may avoid the q interpolation prior to the filtered back projection reconstruction, resulting in improved spatial resolution, reduction of computational effort and improved image quality.

The present invention relates to the field of computer tomography, for example in medical applications. In particular, the present invention relates to a computer tomography apparatus, to a radiation detector, to a method of examination of an object of interest in a computer tomography apparatus and to a computer program for performing an examination of an object of interest in a computer tomography apparatus.

Coherent scatter (CS) computed tomography (CT) is a novel imaging method based on coherently scattered x-ray photons. A coherent scattered CT system is built of an x-ray tube, illuminating one slice of the object, and a detection system, both rotating around the patient or other object to be observed. The detection system may either be a two-dimensional detector, which measures the off-plane scattered photons, or a single-row detector at a distance H out of the plane of primary beams, which performs an energy-resolved measurement of the scattered photons. From the measured projection data, a three-dimensional volume is reconstructed, defined by the two spatial dimensions (x, y) in the plane of primary radiation. The third dimension is parameterized by the momentum transfer q of the scattered photons.

However, prior to the filtered back-projection reconstruction, an interpolation of the momentum transfer values q has to be performed, which may result in reduced image quality and may require additional computational effort.

There is a desire for an improved examination of an object of interest.

In accordance with an exemplary embodiment of the present invention, the above desire may be met by a computer tomography apparatus for examination of an object of interest, the computer tomography apparatus comprising a rotating source of electromagnetic radiation rotating in a plane of rotation and emitting a beam of electromagnetic radiation to an object of interest, a first detecting element adapted for detecting electromagnetic radiation coherently scattered from a first object point of the object of interest with a first energy within a first energy interval, and a second detecting element adapted for detecting electromagnetic radiation coherently scattered from a second object point of the object of interest with a second energy within a second energy interval, wherein the first detecting element is arranged at a to first distance from the plane of rotation and wherein the second detecting element is arranged at a second distance from the plane of rotation, the first distance being essentially equal to the second distance, and wherein the first energy interval is different from the second energy interval.

In other words, a detector is provided comprising a first detecting element and a second detecting element which are positioned on a line parallel to the plane of rotation of the radiation source and which are sensitive to different energy ranges. Therefore, the first detecting element may detect scattered photons of a different energy than the second detecting element.

Advantageously, this may lead to an energy resolved coherent scatter computer tomography apparatus for baggage inspection or medical applications with a Cartesian q-sampling.

According to another exemplary embodiment of the present invention, the first object point and the second object point are positioned on a line perpendicular to a central ray of the beam of electromagnetic radiation.

According to another exemplary embodiment of the present invention, the first energy interval is a predetermined function of a first fan angle between the central ray and a ray emitted from the source to the first object point and wherein the second energy interval is a predetermined function of a second fan angle between the central ray and a ray emitted from the source to the second object point.

Advantageously, since the dependency of the first and second energy intervals on the first and second fan angles, respectively, is predetermined by a function, the first and second detecting elements may be adapted such that they are highly sensitive to radiation energies inside the first and second energy intervals, respectively, before the examination of the object of interest starts.

According to another exemplary embodiment of the present invention, the computer tomography apparatus further comprises a data processor, wherein the data processor is adapted for performing the steps of linear sampling in an energy for each detecting element and applying a parallel-beam rebinning of the beam into a parallel-beam geometry, resulting in an equidistant sampling in an momentum transfer of the detected radiation for each detecting element without interpolation.

Thus, advantageously, a Cartesian sampling in q on a parallel-rebinned detector plane may result without interpolation in q-direction. This yields improved resolution in the reconstruction volume.

According to another exemplary embodiment of the present invention, the first detecting element and the second detecting element are part of a radiation detector, wherein the radiation detector is one of a focus-centred single-row energy-resolved detector at a constant distance from the plane of rotation and a planar single-row energy-resolved detector at a constant distance from the plane of rotation.

Advantageously, this may increase the computational efficiency of the computer tomography apparatus.

According to another exemplary embodiment of the present invention, the source of electromagnetic radiation is a polychromatic x-ray source, wherein the source moves along a helical path around the object of interest and wherein the beam has a fan-beam geometry.

The application of a polychromatic x-ray source may be advantageous, since polychromatic x-rays are easy to generate and provide a high photon flux.

Another exemplary embodiment of the present invention provides for a computer tomography apparatus adapted as a coherent scatter computer tomography apparatus.

The computer tomography apparatus may, be configured as one of the group consisting of a baggage inspection apparatus, a medical application apparatus, a material testing apparatus and a material science analysis apparatus. However, the most preferred field of application of the invention may be baggage inspection and medical applications, since the invention allows for an improvement of spatial resolution, a reduction of computational effort and an improvement of image quality. The invention creates a high-quality automatic system that may automatically recognize certain types of materials and, if desired, trigger an alarm in the presence of dangerous materials. Such an inspection system has employed the computer tomography apparatus of the invention with an x-ray radiation source for emitting x-rays which are transmitted through or scattered from the examined package to a detector, allowing to detect coherently scattered radiation in an energy-resolved manner.

The present invention further relates to a radiation detector, comprising a first detecting element adapted for detecting electromagnetic radiation emitted from a source of electromagnetic radiation and coherently scattered from a first object point of the object of interest with a first energy within a first energy interval, and a second detecting element adapted for detecting electromagnetic radiation emitted from the source of electromagnetic radiation and coherently scattered from a second object point of the object of interest with a second energy within a second energy interval, wherein the first detecting element and the second detecting element are arranged at the same distance from a plane of rotation of the source and wherein the first energy interval is different from the second energy interval.

Advantageously, this may provide for an improved radiation detector, resulting in an improved spatial resolution and improved image quality.

According to another exemplary embodiment of the present invention, a method of examination of an object of interest in a computer tomography apparatus is disclosed, the method comprising the steps of rotating a source of electromagnetic radiation in a plane of rotation, emitting a beam of electromagnetic radiation from the source to an object of interest, detecting electromagnetic radiation coherently scattered from a first object point of the object of interest with a first energy inside a first energy interval by a first detecting element, and detecting electromagnetic radiation coherently scattered from a second object point of the object of interest with a second energy inside a second energy interval by a second detecting element. The first detecting element is arranged at a first distance from the plane of rotation and the second detecting element is arranged at a second distance from the plane of rotation, the first distance being essentially equal to the second distance, and the first energy interval is different from the second energy interval.

The present invention also relates to a computer program, which may, for example, be executed on a processor, such as an image processor. Such a computer program may be part of, for example, a CT scanner system. The computer program, according to an exemplary embodiment of the present invention, may be preferably loaded into working memories of a data processor. The data processor may be thus equipped to carry out exemplary embodiments of the methods of the present invention. The computer program may be written in any suitable programming language, such as, for example, C++ and may be stored on a computer-readable medium, such as CD-ROM. Also, the computer program may be available from a network, such as the WorldWideWeb, from which it may be downloaded into image processing units or processors, or any suitable computers.

An aspect of the present invention may be that a non-linear energy binning of an energy-resolved single-row detector is provided, which may automatically lead to a Cartesian q-sampling on a parallel rebinned detector. This may obviate the q interpolation prior to the filtered back-projection reconstruction, resulting in improved spatial resolution, reduction of computational effort and improved image quality.

The aspects defined above and further aspects of the invention are apparent from the examples of embodiments to be described hereinafter and are explained with reference to these examples of embodiments.

Exemplary embodiment of the present invention will be described in the following, with reference to the following drawings:

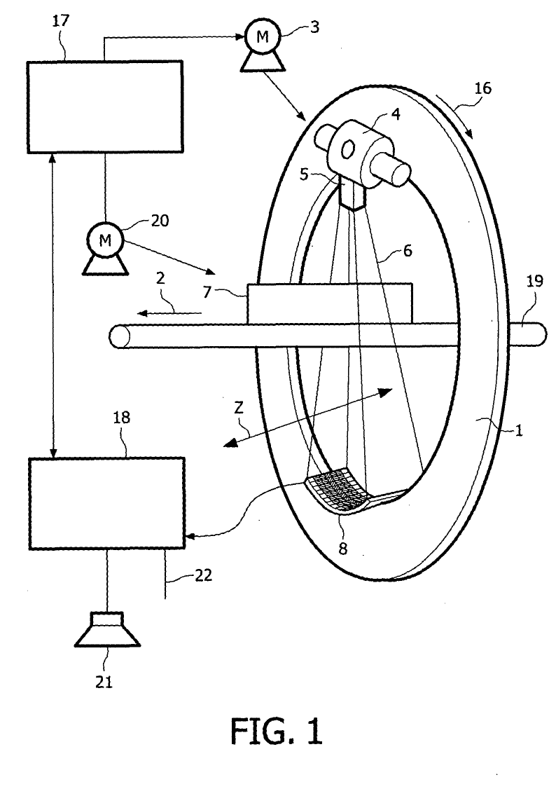

FIG. 1 shows a simplified schematic representation of an embodiment of a computer tomography (CT) scanner according to the present invention.

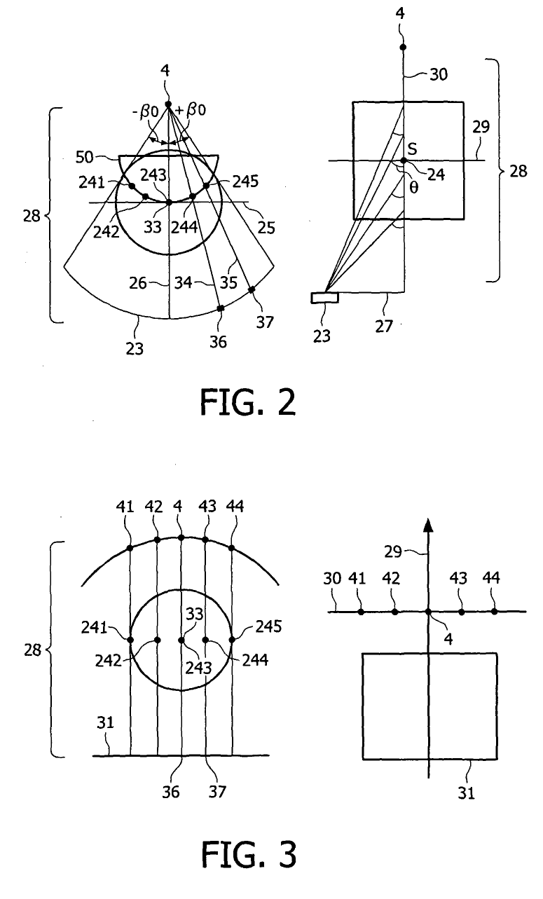

FIG. 2 shows a schematic representation of a CSCT acquisition geometry according to an exemplary embodiment of the present invention.

FIG. 3 shows a schematic representation of a CSCT acquisition geometry after fan-beam to parallel-beam rebinning according to an exemplary embodiment of the present invention.

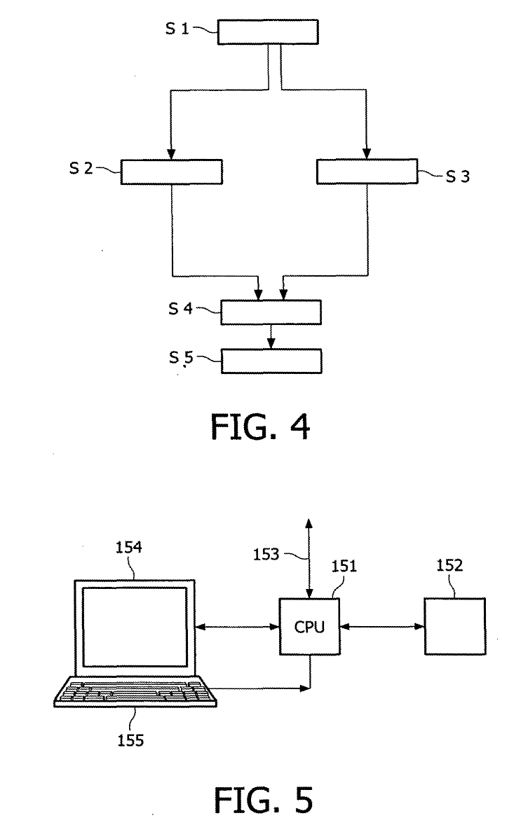

FIG. 4 shows a flow-chart of an exemplary embodiment of a method according to the present invention.

FIG. 5 shows an exemplary embodiment of an image processing device according to the present invention for executing an exemplary embodiment of a method in accordance with the present invention.

In different drawings, similar or identical elements are provided with the same reference numerals.

In the following, referring to FIG. 1, a computer tomography apparatus will be described having implemented energy-resolved CSCT.

With reference to this exemplary embodiment, the present invention will be described for the application in medical imaging. However, it should be noted that the present invention is not limited to the application in the field of medical imaging, but may be used in applications such as baggage inspection to detect hazardous materials, such as explosives, in items of baggage or other industrial applications, such as material testing.

The scanner depicted in FIG. 1 is a fan-beam CT scanner. The CT scanner depicted in FIG. 1 comprises a gantry 1, which is rotatable around a rotational axis 2. The gantry 1 is driven by means of a motor 3. Reference numeral 4 designates a source of radiation, such as an x-ray source, which, according to an aspect of the present invention, emits a polychromatic radiation beam.

Reference numeral 5 designates an aperture system which forms a radiation beam emitted from the radiation source to a cone-shaped radiation beam 6. After emitting a cone-shaped radiation beam 6, the beam may be guided through a slit collimator (not shown in FIG. 1) to form a primary fan-beam impinging on an object 7 to be located in an object region.

The fan-beam 6 (which in FIG. 1 is represented in an exaggerated manner; in reality it may only impinge on the central row of detecting elements, if not scattered along it's path) is now directed such that it penetrates the object of interest 7 arranged in the center of the gantry 1, i.e. in an examination region of the CSCT scanner and impinges onto the detector 8. As may be taken from FIG. 1, the detector 8 is arranged on the gantry 1 opposite the source of radiation 4, such that the surface of the detector 8 is covered by the fan-beam 6. The detector 8 depicted in FIG. 1 comprises a plurality of detector elements.

During a scan of the object of interest 7, the source of radiation 4, the aperture system 5 and detector 8 are rotated along the gantry 1 in the direction indicated by arrow 16. For rotation of the gantry 1 with the source of radiation 4, the aperture system 5 and the detector 8, the motor 3 is connected to a motor control unit 17, which is connected to a calculation unit 18.

During a scan, the radiation detector 8 is sampled at predetermined time intervals. Sampling results read from the radiation detector 8 are electrical signals, i.e. electrical data, which are referred to as projection in the following. A whole data set of a whole scan of an object of interest therefore consists of a plurality of projections where the number of projections corresponds to the time interval with which the radiation detector 8 is sampled. A plurality of projections together may also be referred to as volumetric data. Furthermore, the volumetric data may also comprise electrocardiogram data.

In FIG. 1, the object of interest is disposed on a conveyor belt 19. During the scan of the object of interest 7, while the gantry 1 rotates around the patient 7, the conveyor belt 19 displays the object of interest 7 along a direction parallel to the rotational axis 2 of the gantry 1. By this, the object of interest 7 is scanned along a helical scan path. The conveyor belt 19 may also be stopped during the scans. Instead of providing a conveyor belt 19, for example, in medical applications, where the object of interest 7 is a patient, a movable table may be used. However, it should be noted that in all of the described cases it is also possible to perform a circular scan, where there is no displace meant in a direction parallel to the rotational axis 2, but only the rotation of the gantry 1 around the rotational axis 2.

The detector 8 is connected to the calculation unit 18. The calculation unit 18 receives the detection result, i.e. the read-outs from the detector element of the detector 8, and determines a scanning result on the basis of the read-outs. The detector elements of the detector 8 may be adapted to measure the attenuation caused to the fan-beam 6 by the object of interest 7 or the energy and intensity of x-rays coherently scattered from an object point of the object of interest 7 with an energy inside a certain energy interval. Furthermore, the calculation unit 18 communicates with the motor control unit 17 in order to coordinate the movement of the gantry 1 with motor 3 and 20 or with the conveyor belt 19.

The calculation unit 18 may be adapted for reconstructing an image from read-outs of the detector 8. The image generated by the calculation unit 18 may be output to a display (not shown in FIG. 1) via an interface 22.

The calculation unit 18 which may be realized by a data processor may also be adapted to perform a linear sampling in an energy for each detector element and to perform an application of a parallel-beam rebinning of the beam into a parallel-beam geometry. This, according to an aspect of the present invention, may result in an equidistant sampling in an momentum transfer of the detected radiation for each detector element without interpolation.

Furthermore, as may be taken from FIG. 1, the calculation unit 18 may be connected to a loudspeaker 21 to, for example, automatically output an alarm.

FIG. 2 shows a schematic representation of a CSCT acquisition geometry according to an exemplary embodiment of the present invention. The CSCT geometry depicted in FIG. 2, shows a single line focus-centered detector 23, which may be part of a CSCT computer tomography apparatus according to an exemplary embodiment of the present invention on which a method according to an exemplary embodiment of the present invention may be performed.

In case that an energy-resolved focus-centered single-row detection system 23 at a distance 27 from the plane of primary beams is used, the scatter angle Θ from object points 241, 242, 243, 244, 245 on a circular arc 50 (with its centre halfway between source 4 and the centre of rotation 33) varies as a non-linear function of the fan angle β.

This effect may, according to the present invention, be corrected by adjusting the upper and lower limit of the energy sampling range as a function of the fan angle β. Between these two values, which differ from element to element in the detector row, the energy may be sampled in a linear fashion. Subsequent fan-beam to parallel-beam rebinning into a parallel beam geometry automatically results in a rectangular shaped detector plane with equidistant q-rows on the new detector.

This technique may improve the spatial resolution in CSCT reconstruction, since one interpolation step is carried out as detector dependent energy binning. In addition, the computational efficiency is increased, since one interpolation must not be carried out during the pre-processing of the reconstruction. Finally, the rectangular detector shape containing equidistant q-rows leads to CSCT reconstruction results with improved image quality compared to standard filtered back-projection approaches.

The basic method of filtered back-projection reconstruction for coherent scatter computed tomography has been described in U. van Stevendaal, J.-P. Schlomka, A. Harding, and M. Grass “A reconstruction algorithm for coherent scatter computed tomography based on filtered back-projection”, Med. Phys. 30 (9) (2003) pp. 2465-2474, which is hereby incorporated by reference.

The present invention discloses a CSCT system with a single row detector at a distance 27 out of the plane of primary beams 30, which performs an energy-resolved measurement of the scattered photons. From the measured projection data, a three-dimensional volume is reconstructed defined by the two spatial dimensions (x, y) in the plane of primary radiation 30 and the third dimension is parameterized by the momentum transfer q of the scattered photons. Non-linear energy binning of an energy-resolved detector row 23, comprising detecting elements 36 and 37, is performed, which may automatically lead to a Cartesian q sampling on a parallel rebinned detector 31 (see FIG. 3). This may avoid the q interpolation during the reconstruction.

A first ray of radiation, which is emitted from the source 4 the first point of interest 244 under a first fan-angle between the central ray 26 and the ray from source 4 to point 244, is scattered at the first point of interest 244 under a first scatter angle to the first detecting element 36. Furthermore, a second ray of radiation, emitted from the source 4 to the second object point 245 (under a second fan-angle), is coherently scattered from the second object point 245 towards the second detecting element 37.

In case that an energy-resolved focus-centered single-row detection system at a distance 27 from the plane of rotation 30 is used, the scatter angles Θ from object points 244, 245 vary with the respective fan angle β which lies inside the interval [−β₀; +β₀] according to

$$Θ ( β ) = arc tan ( \frac{H}{G - S cos ( β )} ) , \qquad ( 1 )$$

with G and S being the distance from the source to the detector and to the center of rotation 33, respectively. The momentum transfer q is related to the scatter angle and the photon energy according to

q=sin (2)

E is the energy of the photon while h and c mark Planck's constant and the velocity of the light.

Let q₀ be the scatter angle measured at +/−β₀ for a fixed distance H. Let Eₘₐₓ and Eₘᵢₙ be the maximum and minimum energies, which can be detected using the energy-resolved detector 23. At the maximum fan-angle β₀, the maximum detectable momentum transfer is

$${q}_{0} = \frac{{E}_{max}}{hc} sin ( \frac{Θ ( {β}_{0} )}{2} ) , \qquad ( 3 )$$

which is the maximum detectable value for all detector elements of the row.

At the central ray on the detector with fan-angle β_{c}=0° the minimum detectable momentum transfer for all detector elements results as

$${q}_{c} = \frac{{E}_{min}}{hc} sin ( \frac{Θ ( {β}_{c} )}{2} ) . \qquad ( 4 )$$

In order to achieve a constant sampling in q for all different detector element positions with varying fan-angle β, Eₘₐₓ and Eₘᵢₙ have to be chosen as a function of β according to

$$\begin{matrix}{E}_{max} ( β ) = \frac{{hcq}_{0}}{sin ( \frac{Θ ( β )}{2} )} \\ and & ( 5 ) \\ {E}_{min} ( β ) = \frac{{hcq}_{c}}{sin ( \frac{Θ ( β )}{2} )} . & ( 6 )\end{matrix}$$

Using this maximum and minimum sampling energy per detector element and a linear sampling of the energy range in between, a Cartesian is sampling in q on a parallel-rebinned detector plane results without interpolation in q-direction. This may yield to an improved resolution in the reconstruction volume.

For a planar single-line energy-resolved detector, the relation between the scatter angle Θ and the fan-angle β is

Θ(β)=arctan (7)

which enters the relation for the minimum and maximum measurable momentum transfer (see equations 3, 4) and corresponding borders of the detector element specific energy borders (see equations 5, 6). For single line detectors of different shape this technique may also be applied in order to reduce the loss and spatial resolution due to interpolation in q-direction.

FIG. 3 shows a schematic representation of a CSCT acquisition geometry after fan-beam to parallel-beam rebinning according to an exemplary embodiment of the present invention. The left image of FIG. 3 is a sectional view along the rotational axis 29 and the right image is a sectional view perpendicular to the rotational axis 29. Due to the variable energy binning per detector element, which is represented by the extended source 4, 41, 42, 43, 44, a rectangular detector 31 with equidistant q-rows results.

The rotating source 4 of electromagnetic radiation is rotating in a plane 30 and emits a beam of electromagnetic radiation to the object points 241, 242, 243, 244 and 245, which are now arranged on a line perpendicular to the axis of rotation 29. The electromagnetic radiation is scattered by the object points and subsequently detected by detection elements which are part of linear detector 31. After performing a linear sampling in an energy for each detecting element and applying a parallel-beam rebinning of the beam into a parallel-beam geometry, an equidistant sampling in an momentum transfer of the detected radiation for each detecting element results without additional interpolation.

FIG. 4 shows a flow-chart of an exemplary embodiment of a method according to the present invention. The method starts at step S1 with an acquisition of a projection data set. This may, for example, be performed by using a suitable CSCT scanner system or by reading the projection data from a storage. After that, in step S2, electromagnetic radiation which is coherently scattered from a first object point of the object of interest with an energy inside a first energy interval is detected by a first detecting element. At the same time, or before, or after that, electromagnetic radiation coherently scattered from a second object point of the object of interest with an energy inside a second energy interval is detected by a second detecting element. The first and the second detecting elements are arranged at a same distance from the plane of rotation of the rotating source and for one of a focus-centered single-row energy-resolved detector or a planar single-row energy-resolved detector. The first energy interval is different from the second energy interval. Both, the first and the second energy interval, correspond to a respective fan-angle and may be determined by a predetermined function of the respective fan-angle between the central ray and a ray emitted from the source to the respective object point.

The first object point and the second object point are positioned on a line perpendicular to a central ray of the beam of electromagnetic radiation.

In a further step, a linear sampling in an energy for each detector element is performed and a parallel-beam rebinning of the beam into a parallel-beam geometry is applied, resulting in an equidistant sampling in an momentum transfer (q) of the detected radiation for each detector element without interpolation.

FIG. 5 depicts an exemplary embodiment of a data processing device according to the present invention for executing an exemplary embodiment of a method in accordance with the present invention. The data processing device depicted in FIG. 5 comprises a central processing unit (CPU) or image processor 151 connected to a memory 152 for storing an image depicting an object of interest. The data processor 151 may be connected to a plurality of input/output network or diagnosis devices, such as a CSCT apparatus. The data processor may furthermore be connected to a display device 154, for example, a computer monitor, for displaying information or an image computed or adapted in the data processor 151. An operator or user may interact with the data processor 151 via a keyboard 155 and/or other output devices, which are not depicted in FIG. 5.

Furthermore, via the bus system 153, it may also be possible to connect the image processing and control processor 151 to, for example, a motion monitor, which monitors a motion of the object of interest. In case, for example, a lung of a patient is imaged, the motion sensor may be an exhalation sensor. In case, the heart is imaged, the motion sensor may be an electrocardiogram.

It should be noted, that the term “comprising” does not exclude other elements or steps and the “a” or “an” does not exclude a plurality and that a single processor or system may fulfil the functions of several means recited in the claims. Also elements described in association with different embodiments may be combined.

It should also be noted, that any reference signs to the claims shall not be construed as limiting the scope of the claims.

1. A computer tomography apparatus for examination of an object of interest, the computer tomography apparatus comprising:
a rotating source (4) of electromagnetic radiation rotating in a plane of rotation and emitting a beam of electromagnetic radiation to an object of interest (7);
a first detecting element adapted for detecting electromagnetic radiation coherently scattered from a first object point (244) of the object of interest (7) with a first energy within a first energy interval;
a second detecting element adapted for detecting electromagnetic radiation coherently scattered from a second object point (245) of the object of interest (7) with a second energy within a second energy interval;
wherein the first detecting element is arranged at a first distance from the plane of rotation and the second detecting element is arranged at a second distance from the plane of rotation, the first distance being essentially equal to the second distance; and
wherein the first energy interval is different from the second energy interval.

2. The computer tomography apparatus of claim 1, wherein the first object point (244) and the second object point (245) are positioned on a line perpendicular to a central ray of the beam of electromagnetic radiation.

3. The computer tomography apparatus of claim 1,
wherein the first energy interval is a predetermined function of a first fan angle between the central ray and a ray emitted from the source (4) to the first object point (244); and
wherein the second energy interval is a predetermined function of a second fan angle between the central ray and a ray emitted from the source (4) to the second object point (245).

4. The computer tomography apparatus of claim 1, further comprising a data processor, wherein the data processor (151) is adapted for performing the steps of:
linear sampling in an energy for each detecting element; and
applying a parallel-beam rebinning of the beam into a parallel beam geometry, resulting in an equidistant sampling in an momentum transfer of the detected radiation for each detecting element without interpolation.

5. The computer tomography apparatus of claim 1,
wherein the first detecting element and the second detecting element are part of a radiation detector; and
wherein the radiation detector is one of a focus-centred single-row energy-resolved detector at a constant distance from the plane of rotation and a planar single-row energy-resolved detector at a constant distance from the plane of rotation.

6. The computer tomography apparatus of claim 1,
wherein the source (4) of electromagnetic radiation is a polychromatic x-ray source;
wherein the source (4) moves along a helical path around the object of interest (7); and
wherein the beam has a fan-beam geometry.

7. The computer tomography apparatus of claim 1, being adapted as a coherent scatter computer tomography apparatus.

8. The computer tomography apparatus of claim 1, configured as one of the group consisting of a baggage inspection apparatus, a medical application apparatus, a material testing apparatus and a material science analysis apparatus.

9. A radiation detector comprising:
a first detecting element adapted for detecting electromagnetic radiation emitted from a source (4) of electromagnetic radiation and coherently scattered from a first object point (244) of the object of interest (7) with a first energy within a first energy interval;
a second detecting element adapted for detecting electromagnetic radiation emitted from the source (4) of electromagnetic radiation and coherently scattered from a second object point (245) of the object of interest (7) with a second energy within a second energy interval;
wherein the first detecting element is arranged at a first distance from the plane of rotation and the second detecting element is arranged at a second distance from the plane of rotation, the first distance being essentially equal to the second distance; and
wherein the first energy interval is different from the second energy interval.

10. The radiation detector of claim 9,
wherein the first object point (244) and the second object point (245) are positioned on a line perpendicular to a central ray of the beam of electromagnetic radiation;
wherein the first energy interval is a predetermined function of a first fan angle between the central ray and a ray emitted from the source (4) to the first object point (244); and
wherein the second energy interval is a predetermined function of a second fan angle between the central ray and a ray emitted from the source (4) to the second object point (245).

11. The radiation detector of claim 9, wherein a linear sampling in an energy for each detector element and an application of a parallel-beam rebinning of the beam into a parallel beam geometry results in an equidistant sampling in an momentum transfer of the detected radiation for each detecting element without interpolation.

12. The radiation detector of claim 9, wherein the radiation detector is one of a focus-centred single-row energy-resolved detector at a constant distance from the plane of rotation and a planar single-row energy-resolved detector.

13. A method of examination of an object of interest (7) in a computer tomography apparatus, the method comprising the steps of:
rotating a source (4) of electromagnetic radiation in a plane of rotation;
emitting a beam of electromagnetic radiation from the source (4) to an object of interest;
detecting electromagnetic radiation coherently scattered from a first object point (244) of the object of interest (7) with a first energy within a first energy interval by a first detecting element;
detecting electromagnetic radiation coherently scattered from a second object point (245) of the object of interest (7) with a second energy within a second energy interval by a second detecting element;
wherein the first detecting element is arranged at a first distance from the plane of rotation and the second detecting element is arranged at a second distance from the plane of rotation, the first distance being essentially equal to the second distance; and
wherein the first energy interval is different from the second energy interval.

14. The method of claim 13, further comprising the steps of:
linear sampling in an energy for each detector element; and
applying a parallel-beam rebinning of the beam into a parallel beam geometry, resulting in an equidistant sampling in an momentum transfer of the detected radiation for each detector element without interpolation;
wherein the first object point (244) and the second object point (245) are positioned on a line perpendicular to a central ray of the beam of electromagnetic radiation;
wherein the first energy interval is a predetermined function of a first fan angle between the central ray and a ray emitted from the source (4) to the first object point (244); and
wherein the second energy interval is a predetermined function of a second fan angle between the central ray and a ray emitted from the source (4) to the second object point (245).

15. A computer program for performing an examination of an object of interest (7) in a computer tomography apparatus, wherein the computer program causes a processor to perform the following operation when the computer program is executed on the processor:
loading a data set acquired by means of a rotating source (4) of electromagnetic radiation rotating in a plane of rotation and emitting a beam of electromagnetic radiation to an object of interest, the data set comprising
data detected by a first detecting element and corresponding to electromagnetic radiation coherently scattered from a first object point (244) of the object of interest (7) with a first energy within a first energy interval; and
data detected by a second detecting element and corresponding to electromagnetic radiation coherently scattered from a second object point (245) of the object of interest (7) with a second energy within a second energy interval;
wherein the first detecting element is arranged at a first distance from the plane of rotation and the second detecting element is arranged at a second distance from the plane of rotation, the first distance being essentially equal to the second distance; and
wherein the first energy interval is different from the second energy interval.
